(19) United States
(12) Patent Application Publication
(10) Pub. No.: US 2019/0113644 A1
(43) Pub. Date: Apr. 18, 2019

(54) Marine Seismic Use of a Harmonic Distorted Signal

(71) Applicant: PGS Geophysical AS, Oslo (NO)

(72) Inventors: Walter F. Söllner, Oslo (NO); Okwudili Orji, Oslo (NO)

(73) Assignee: PGS Geophysical AS, Oslo (NO)

(21) Appl. No.: 16/160,005

(22) Filed: Oct. 15, 2018

Related U.S. Application Data
(60) Provisional application No. 62/572,150, filed on Oct. 13, 2017.

(51) Int. Cl. G01V 1/38; G01V 1/18; G01V 1/28; G01V 1/30

(52) U.S. Cl. CPC G01V 1/3808; G01V 1/3843; G01V 1/307; G01V 1/282; G01V 1/18

(57) ABSTRACT

Marine seismic use of a harmonic distorted signal can include calculating a source wavefield based on nearfield measurements of a direct arrival signal from a marine vibrator source including harmonic distortion, calculating a receiver wavefield based on far-field measurements of a signal from the marine vibrator source after reflection from a subsurface location, and performing a multidimensional deconvolution of a source ghost effect, a source signature effect, and the harmonic distortion from the calculated receiver wavefield to determine a reflectivity of the subsurface location with the harmonic distortion suppressed.

### CROSS-REFERENCE TO RELATED APPLICATIONS

This application claims priority to U.S. Provisional Application 62/572,150, filed Oct. 13, 2017, which is incorporated by reference.

### BACKGROUND

The petroleum industry has invested heavily in the development of marine survey techniques that yield knowledge of subterranean formations beneath a body of water in order to find and extract valuable mineral resources, such as oil. High-resolution images of a subterranean formation are helpful for quantitative interpretation and improved reservoir monitoring. For a typical marine survey, a marine survey vessel tows one or more marine survey sources below the sea surface and over a subterranean formation to be surveyed for mineral deposits. Marine survey receivers may be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control may cause the one or more marine survey sources, which can be impulsive sources such as air guns, non-impulsive sources such as marine vibrator sources, electromagnetic sources, etc., to produce signals at selected times. Each signal is essentially a wave called a wavefield that travels down through the water and into the subterranean formation. At each interface between different types of rock, a portion of the wavefield may be refracted, and another portion may be reflected, which may include some scattering, back toward the body of water to propagate toward the sea surface. The marine survey receivers thereby measure a wavefield that was initiated by the actuation of the marine survey source.

### BRIEF DESCRIPTION OF THE DRAWINGS

FIG. 1 is an elevation or xz-plane view of an example of marine surveying in which signals are emitted by a marine survey source for recording by marine survey receivers.

FIG. 2A is a plot of amplitude spectra for an example of a sweep signal with and without harmonic distortion.

FIG. 2B illustrates a portion of the plot illustrated in FIG. 2A in more detail.

FIG. 3 is a spectrogram of the sweep signal illustrated in FIG. 2A with decomposed fundamental mode and harmonic modes.

FIG. 4 illustrates an example of modeled subsurface reflectivity without harmonic distortion.

FIG. 5 illustrates calculated subsurface reflectivity based on a cross-correlation of modeled data with harmonic distortion.

FIG. 6 illustrates the difference between the calculated subsurface reflectivity in FIG. 5 and the modeled subsurface reflectivity in FIG. 4 after convolution with the autocorrelation of the original sweep to simulate the cross-correlation based result.

FIG. 7 illustrates elevation or xz-plane views of various states of an acoustic model representing marine surveying in which signals are emitted by a marine survey source for recording by marine survey receivers.

FIG. 8 illustrates calculated subsurface reflectivity based on a multidimensional deconvolution of modeled data with harmonic distortion according to at least one embodiment of the present disclosure.

FIG. 9 illustrates the difference between the calculated subsurface reflectivity in FIG. 8 and the modeled subsurface reflectivity in FIG. 4.

FIG. 10 is a method flow diagram for marine seismic use of a harmonic distorted signal.

FIG. 11 illustrates a diagram of an example of a machine-readable medium for marine seismic use of a harmonic distorted signal.

FIG. 12 illustrates a diagram of an example of a system for marine seismic use of a harmonic distorted signal.

### DETAILED DESCRIPTION

The present disclosure is related to marine seismic use of a harmonic distorted signal. A marine seismic source is a device that generates controlled acoustic energy used to perform marine surveys based on reflection and/or refraction of the acoustic energy. The present disclosure relates to a class of non-impulsive marine seismic sources that are marine vibrator sources. Impulsive sources, such as air guns, generally do not generate harmonic distorted signals. However, marine vibrator sources can generate harmonic distorted signals. Harmonic distortion is the presence of frequencies in the output of a device that are not present in the input signal. For example, harmonic distortion can add overtones that are multiples of an acoustic signal's frequencies. Some previous approaches to marine seismic imaging may attempt to reduce the harmonic distortion caused by the marine vibrator source. For example, iterative learning control (ILC) has been used in attempt to suppress harmonic distortion. However, ILC can result in a more limited frequency band of operation for the marine vibrator source. For example, ILC may eliminate some higher frequencies, which can reduce image quality by limiting the response from the subsurface at those frequencies. In contrast, at least one embodiment of the present disclosure makes use of the positive aspects of harmonic distortion, allowing broadband use of the marine vibrator source at desired frequencies, while still suppressing harmonic distortion by reducing or eliminating artefacts from the harmonic distortion in marine seismic imaging.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection.

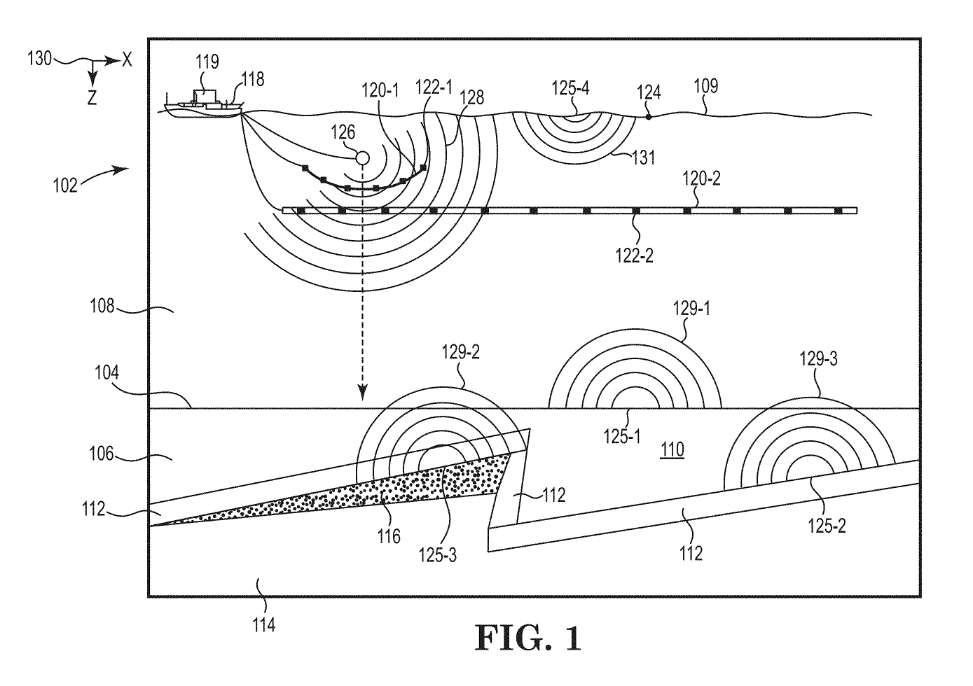

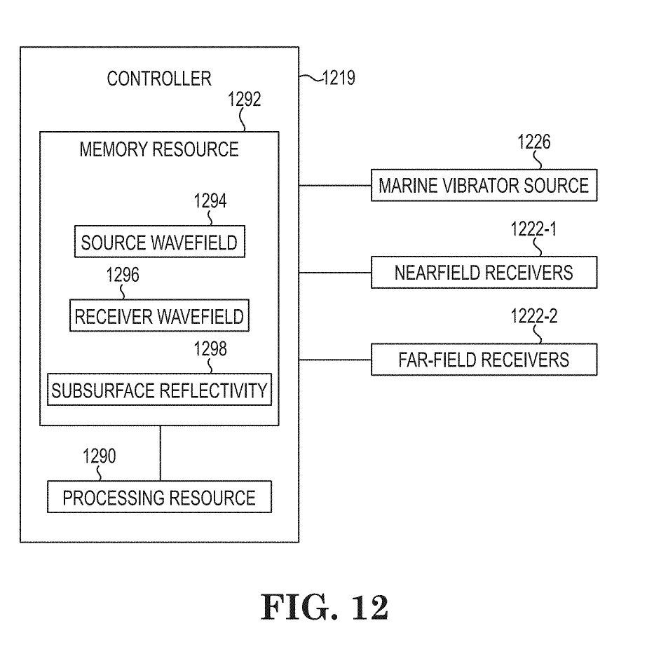

The figures herein follow a numbering convention in which the first digit or digits correspond to the drawing figure number and the remaining digits identify an element or component in the drawing. Similar elements or components between different figures may be identified by the use of similar digits. For example, 119 may reference element “19” in FIG. 1, and a similar element may be referenced as 1219 in FIG. 12. Analogous elements within a Figure may be referenced with a hyphen and extra numeral or letter. See, for example, elements 122-1, and 122-2 in FIG. 1. Such analogous elements may be generally referenced without the hyphen and extra numeral or letter. For example, elements 122-1 and 122-2 may be collectively referenced as 122. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is an elevation or xz-plane 130 view of an example of marine surveying in which signals are emitted by a marine survey source 126 for recording by marine survey receivers 122. The recording can be used for processing and analysis in order to help characterize the structures and distributions of features and materials underlying the surface of the earth. For example, the recording can be used to estimate a physical property of a subsurface location, such as the presence of a reservoir that may contain hydrocarbons. FIG. 1 shows a domain volume 102 of the earth's surface comprising a subsurface volume 106 of sediment and rock below the surface 104 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, underlying rock layer 114, and hydrocarbon-saturated layer 116. One or more elements of the subsurface volume 106, such as the first sediment layer 110 and the uplifted rock layer 112, can be an overburden for the hydrocarbon-saturated layer 116. In some instances, the overburden may include salt.

FIG. 1 shows an example of a marine survey vessel 118 equipped to carry out marine surveys. The marine survey vessel 118 can tow one or more streamers 120-1, 120-2 generally located below the sea surface 109. The first streamer 120-1 is deployed proximally to the marine vibrator source 126. The second streamer 120-2 is deployed distally from the marine vibrator source 126 (relative to the first streamer 120-1). The streamers 120 can be cables containing power and data-transmission lines (e.g., electrical, optical fiber, etc.) to which marine survey receivers 122 may be coupled. For example, the first streamer 120-1 includes marine survey receivers represented by the shaded disk near the numeral 122-1 and the second streamer 120-2 includes marine survey receivers represented by the shaded disk near the numeral 122-2. The first streamer 120-1 may be curved to form a hemispherical-shape or curve-shape below the marine vibrator source 126 and with the marine vibrator source 126 near the center of the shape, which can help the marine survey receivers, such as marine survey receiver 122-1, to measure a radially expanding source wavefield 128 normal to the wavefront of the source wavefield 128. The nearfield receivers, such as marine survey receiver 122-1, can receive a direct arrival signal, which is a signal that has not reflected or refracted from the surface 104, or subsurface volume 106, but is received from the marine vibrator source 126. Although the second streamer 120-2 is illustrated as being substantially parallel to the surface 104, in practice, the shape of the streamers 120 may vary as a result of, for example, dynamic conditions of the body of water in which the streamers are submerged.

In at least one embodiment, each marine survey receiver 122 comprises a pair of sensors including a geophone that detects particle displacement within the water by detecting particle motion variation, such as velocities or accelerations, and/or a hydrophone that detects variations in pressure. The streamers 120 and the marine survey vessel 118 can include sensing electronics and data-processing facilities that allow marine survey receiver readings to be correlated with absolute locations on the sea surface and absolute three-dimensional locations with respect to a three-dimensional coordinate system. In FIG. 1, the marine survey receivers 122 along the streamers 120 are shown to lie below the sea surface 109, with the marine survey receiver locations correlated with overlying surface locations, such as a surface location 124 correlated with the location of a far-field receiver 122-2. By way of example, “nearfield” can include measurements taken a distance from the marine vibrator source that is less than, approximately equal to, or on the same order of magnitude as, the wavelength of the signal emitted by the marine vibrator source, and “far-field” can include measurements taken a distance from the seismic source much greater than the wavelength. The marine survey vessel 118 can include a controller 119, which is described in more detail with respect to FIG. 12. For example, the controller 119 can be coupled to the streamer 120-2 and configured to receive data from the marine survey receivers 122 therein in order to perform marine seismic analysis.

The marine survey vessel 118 can tow one or more marine survey sources, such as the marine vibrator source 126, that produce signals as the marine survey vessel 118 moves across the sea surface 109 with the streamers 120 in tow. A marine vibrator source can include at least one moving plate. The marine vibrator source can be controlled with a time signal from the controller 119 on the marine survey vessel 118 that controls motion of the at least one plate of the marine vibrator source. For example, where the motion of the plate can be described as a sweep (where the frequency changes with time), the time signal can be referred to as a sweep signal. An example of a marine vibrator source is a bender source, which is a flexural disc projector. A bender source may employ one or more piezoelectric elements, such that the mechanical vibration of the bender source is driven by piezoelectric distortion based on electrical energy applied to the piezoelectric element. Marine survey sources and/or streamers 120 may also be towed by other vessels or may be otherwise disposed in fluid volume 108. For example, marine survey receivers may be located on ocean bottom cables or nodes fixed at or near the surface 104, and marine survey sources may also be disposed in a nearly-fixed or fixed configuration. For the sake of efficiency, illustrations and descriptions herein show marine survey receivers located on streamers, but it should be understood that references to marine survey receivers located on a “streamer” or “cable” should be read to refer equally to marine survey receivers located on a towed streamer, an ocean bottom receiver cable, and/or an array of nodes.

FIG. 1 shows acoustic energy illustrated as an expanding, spherical signal, illustrated as semicircles of increasing radius centered at the marine vibrator source 126, representing the source wavefield 128, following a signal emitted by the marine vibrator source 126. The source wavefield 128 is, in effect, shown in a vertical plane cross section in FIG. 1. The outward and downward expanding source wavefield 128 may eventually reach the surface 104, at which point the outward and downward expanding source wavefield 128 may partially scatter, may partially reflect back toward the streamers 120, and may partially refract downward into the subsurface volume 106, becoming elastic signals within the subsurface volume 106. Waves of significant amplitude may be generally reflected from points on or close to the surface 104, such as point 125-1, and from points on or very close to interfaces within the subsurface volume 106, such as points 125-2 and 125-3. The upward expanding reflected waves 129-1, 129-2, 129-3 are referred to as a “reflected wavefield” and as a “receiver wavefield” when measured by one or more seismic receivers 122.

Because the surface of a body of water reflects acoustic energy, source “ghost” effects created by sea surface 109 reflections contaminate seismic data gathered by the marine survey receivers 122. The source ghost effects result from portions of the acoustic energy being reflected from the sea surface 109 before reaching the marine survey receivers 122 and from acoustic energy that travels upward from the surface 104 and is reflected by the sea surface 109 before reaching the marine survey receivers 122. As a result, the marine survey receivers 122 measure not only portions of the reflected wavefields that travel directly from the surface 104 to the marine survey receivers 122, but also measure time-delayed (ghost) wavefields 131 created by reflections at points 125-4 on the sea surface 109.

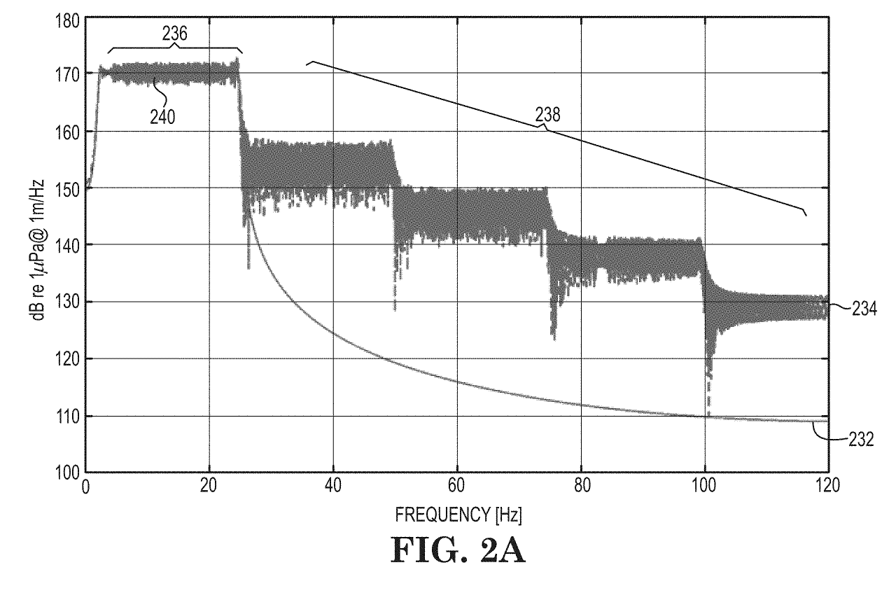

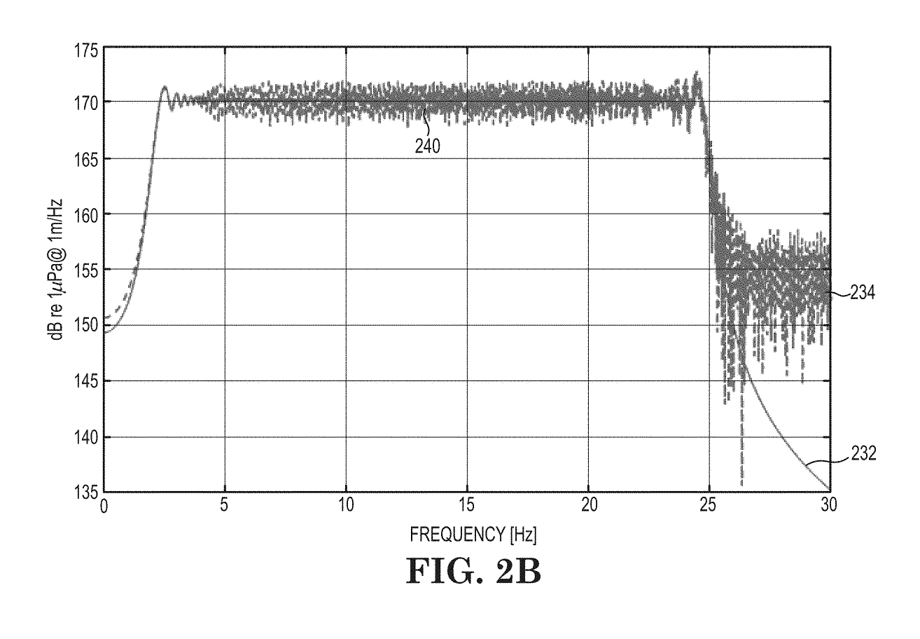

FIG. 2A is a plot of amplitude spectra for an example of a sweep signal with and without harmonic distortion. FIG. 2B illustrates a portion of the plot illustrated in FIG. 2A in more detail. The amplitude spectrum for the sweep signal without harmonic distortion 232 and the amplitude spectrum for the sweep signal with harmonic distortion 234 are illustrated. The vertical axis is the amplitude (power/frequency) in decibels (dB) relative to 1 micropascal at 1 meter/Hertz (Hz) (“re 1 μPa@1 m/Hz”) and the horizontal axis is the frequency in Hz. Although not clearly visible based on the plot, the portion of the amplitude spectrum for the sweep signal without harmonic distortion 232 from 1 to 25 Hz is a generally flat line at 170 dB with small oscillations due to limited signal length (Gibbs effect). By way of example, the sweep signal can sweep from 2 to 25 Hz over sixty seconds at a depth of 30 meters below the surface, however embodiments are not limited to specific frequency ranges, durations, or depths. In-band harmonics 240 occur at percentages of the magnitude of the operational portion 236 of the sweep signal. The operational portion 236 of the sweep signal is the portion during which the marine vibrator is being driven by the sweep signal to vibrate. In the example illustrated in FIG. 2A, the operational portion 236 of the sweep signal is from 1 to 25 Hz. The in-band harmonics 240 occur throughout the frequency range of the operational portion 236 of the sweep signal. The amplitude spectrum for the sweep signal with harmonic distortion 234 can represent the source signature and includes out-of-band harmonics 238 that are percentages of the fundamental amplitudes. At least one embodiment of the present disclosure does not include other sources, such as impulsive sources or additional marine vibrator sources, operating during operation of the marine vibrator source.

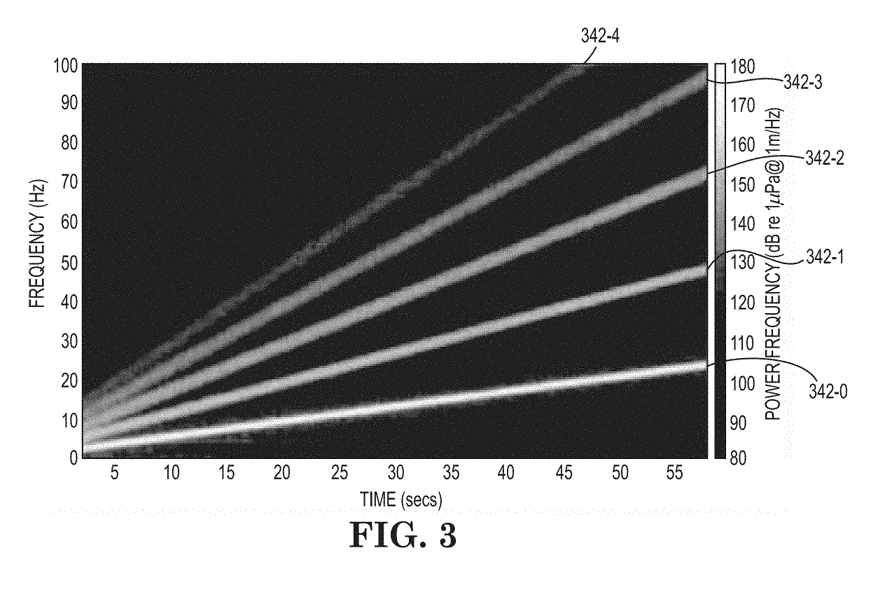

FIG. 3 is a spectrogram of the sweep signal illustrated in FIG. 2A with decomposed fundamental mode and harmonic modes. The vertical axis is frequency in Hz. The horizontal axis is time in seconds. The spectrogram is a time-frequency decomposition that separates the fundamental mode 342-0 of the sweep as well as the harmonics including the first order harmonics 342-1, the second order harmonics 342-2, the third order harmonics 342-3, and the fourth order harmonics 342-4. The shading gradation for the various harmonics represents amplitude in dB re 1 μPa@1 m/Hz, with darker shading representing lesser amplitudes and lighter shading representing greater amplitudes.

The first order harmonics 342-1 of the out-of-band harmonics may also be referred to in the art as second order harmonics when no distinction is made between in-band harmonics and out-of-band harmonics. Likewise, the second order harmonics 342-2 may be referred to as third order harmonics, the third order harmonics 342-3 may be referred to as fourth order harmonics, and the fourth order harmonics 342-4 may be referred to as fifth order harmonics when no distinction is made between in-band harmonics and out-of-band harmonics. However, the discussion herein distinguishes between in-band harmonics and out-of-band harmonics and thus uses a different notation.

The spectrogram can be seen as short-window Fourier transforms. A sum over all windows approximately recovers the amplitude spectrum of the trace. For example, at a short window around 10 s, the fundamental mode 342-0 is at approximaty 5 Hz, the first order harmonics 342-1 is at approximately 10 Hz, the second order harmonics 342-2 is at approxaimately 15 Hz, the third order harmonics 342-3 is at approximately 20 Hz, and the fourth order harmonics 342-4 is at approximately 25 Hz. The sum over all time windows from 0 s to 60 s would add all these distinct events in an aproximate amplitude spectrum of mixed in-band and out-of-band harmonics.

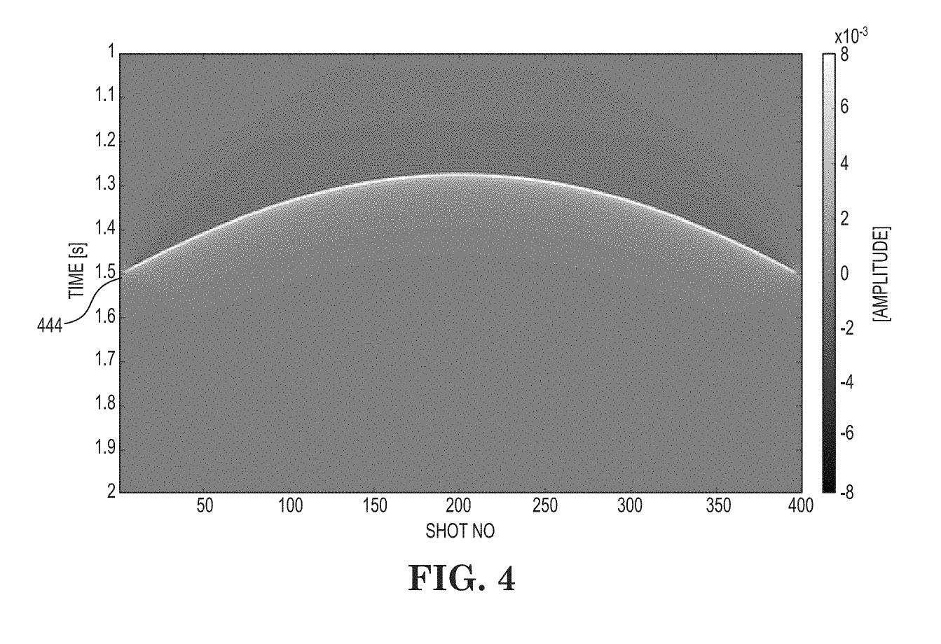

FIG. 4 illustrates an example of modeled subsurface reflectivity 444 without harmonic distortion. The vertical axis is time in seconds. The horizontal axis is shot number. The shading gradation represents relative amplitude. The modeled subsurface reflectivity 444 without harmonic distortion is modeled as a 400 shot trace common receiver gather of a point diffractor. As can clearly be seen in FIG. 4, there is no source ghost effect present in the modeled subsurface reflectivity 444 without harmonic distortion. Equation 2, described below, can be used to recover this reflectivity for harmonic distorted and undistorted signals. FIG. 4 is included for purposes of comparison to images obtained using correlation.

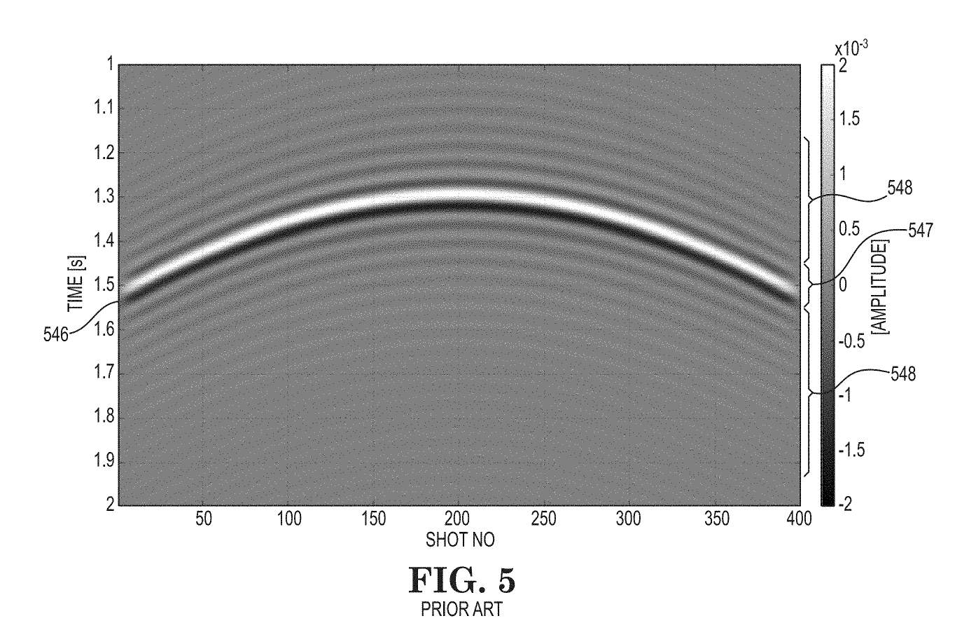

FIG. 5 illustrates calculated subsurface reflectivity 546 based on a cross-correlation of modeled data with harmonic distortion. In FIG. 5, the subsurface reflectivity is included in the data, but it is masked by the cross-correlation wavelet and harmonic artifacts. The vertical axis is time in seconds. The horizontal axis is shot number. The shading gradation represents relative amplitude. The image includes a source ghost effect 547 as indicated by the high contrast (light/dark) in the vicinity of the calculated subsurface reflectivity 546. The image in FIG. 5 includes harmonic distortion 548 appearing as shadows of the calculated subsurface reflectivity 546.

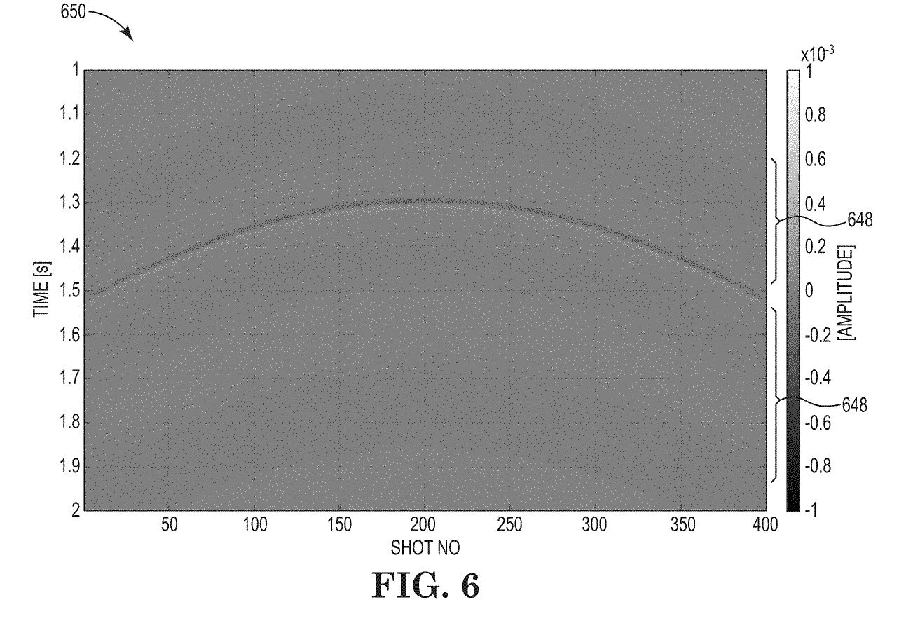

FIG. 6 illustrates the difference 650 between the calculated subsurface reflectivity in FIG. 5 and the modeled subsurface reflectivity in FIG. 4 after convolution with the autocorrelation of the original sweep to simulate the cross-correlation based result (not shown). The vertical axis is time in seconds. The horizontal axis is shot number. The shading gradation represents relative amplitude. As can be seen, artefacts from the harmonic distortion 648 remain in the image.

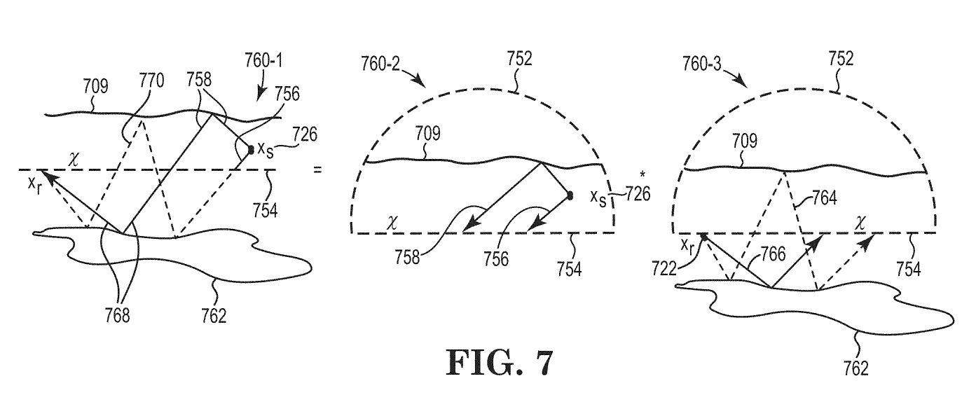

FIG. 7 illustrates elevation or xz-plane views of various states 760-1, 760-2, 760-3 of an acoustic model representing marine surveying in which signals are emitted by a marine survey source for recording by marine survey receivers. As used herein, “wavefield” may refer either to a physical wavefield, such as that generated by a marine vibrator source, or to data representing a physical wavefield, depending on the context. The sea surface 709 is illustrated as a solid line. The horizontal dotted line represents a measurement level 754 located at a depth z=z′ below the sea surface 709. Any point on the measurement level 754 may be denoted by χ. The dotted semicircular curve 752 connected to the ends of the measurement level 754 forms an enclosed hemisphere with a volume that encloses the sea surface 709. The marine vibrator source 726 is identified by its location xₛ between the sea surface 709 and the measurement level 754, where the subscript “s” denotes the source signature of the marine vibrator source 726. A marine survey receiver 722 including pressure and particle motion variation sensors is illustrated at location xᵣ at the measurement level 754 and below the marine vibrator source 726.

The first state 760-1 illustrates the separated up-going wavefield. Assuming wavefield separation on the receiver side, the source signature effect and the source ghost effect present in the up-going wavefield can be designatured (removing the source signature effect) and deghosted (removing the source ghost effect) using the separated up-going wavefield indicated by the heavy solid directional arrow 768 and the dotted directional arrow 770 in the first state 760-1 and the direct down-going wavefield indicated by the directional arrow 756 and the bent directional arrow 758 in the second state 760-2. The direct down-going wavefield can be measured by nearfield receivers, such as those illustrated in association with the streamer 120-1 in FIG. 1.

A pressure wavefield (p) and a velocity wavefield (v) emitted by the marine vibrator source 726 can be separated in up-going components and down-going components. The velocity wavefield can be represented by three orthogonal components. For wavefield extrapolation, in general, an orthogonal component of the velocity wavefield that is normal to the measurement level 754, which may also be referred to as an extrapolation level, is used. Where the measurement level 754 is horizontal, the orthogonal component of the velocity wavefield that is normal to the measurement level 754 can be referred to as a vertical velocity wavefield (v_{z}), where the subscript z indicates vertical. Some of the equations described herein refer to a vertical velocity wavefield by the subscript z for ease of notation, however embodiments are not limited to this particular orthogonal wavefield component, as the measurement level 754 need not be horizontal. Therefore, the velocity wavefield is generally referred to herein without reference to “vertical” because it is not limited as such. The pressure wavefield (p) and a velocity wavefield (v) emitted by the marine vibrator source 726 can be separated in up-going components (up-going pressure wavefield p⁻ and up-going velocity wavefield v_{z}⁻) and down-going components (down-going pressure wavefield p⁺ and down-going velocity wavefield v⁺). In some embodiments, the separation can be modeled at the measurement level 754 associated with a level of the marine survey receiver 722.

After separation of the pressure wavefield and the velocity wavefield, the up-going and down-going wavefields can be extrapolated (e.g., using one-way wave equation techniques) or propagated (e.g., using two-way wave equation techniques) to the measurement level 754. As used herein, a wavefield being extrapolated or propagated refers to a modeling technique for manipulating the wavefield rather than physical propagation of the wavefield, unless otherwise indicated. In the first state 760-1, the down-going pressure wavefield and down-going velocity wavefield can be modeled as though recorded at the measurement level 754.

Provided that a receiver-side pressure wavefield of data based on a signal generated by a marine non-impulsive source, such as a marine vibrator, is available, the source signature effect and the source ghost effect present in the data can be designatured and deghosted using the direct down-going velocity wavefield (of the source wavefield). The source wavefield may be calculated from nearfield measurements. The result is the subsurface reflectivity with harmonics themselves becoming useful signals. This is termed multidimensional deconvolution. A multidimensional deconvolution can reduce or eliminate the cost and complications of using ILC to suppress harmonics while broadening the bandwidth used in imaging for marine vibrator sources, which represents an unconventional technical solution to a technical problem that is an improvement to the technological field of marine seismology and, in particular, determinations of subsurface reflectivity based on marine surveys that use marine vibrator sources. This improvement also eliminates the cost and complications that would otherwise occur if ILC were used to suppress harmonic distortion as in some previous approaches.

The receiver-side (measured) pressure wavefield (left-hand side term) is related to the source ghost affected direct down-going velocity wavefield (right-hand side 1st term) and the subsurface reflectivity (right-hand side 2nd term) as illustrated in FIG. 7 and given in equation 1, below.

Pᵤₚ(xᵣ,xₛ)=−2iωρ∫v_{dn}^{dir}(χ,xₛ)R(xᵣ, χ)dχ (1)

Equation 1 can be rearranged into a matrix form and inverted by multidimensional deconvolution to obtain the designatured and deghosted subsurface reflectivity (left-hand side term in Equation 2) as follows:

R=PᵤₚV_{dn}^{dir}^{^{−1}} (2)

The second state 760-2, which may also be referred to as state A, illustrates the down-going wavefield. The directional arrow 756 represents a portion of a source wavefield generated by the marine vibrator source 726 that travels directly from the marine vibrator source 726 to a point on the measurement level 754. This portion of the source wavefield can be removed by designaturing. The bent directional arrow 758 represent a portion of source wavefield generated by the marine vibrator source 726 that is reflected from the sea surface 709 to the measurement level 754. This portion of the source wavefield can be removed by deghosting.

The third state 760-3, which may also be referred to as state B, illustrates the up-going wavefield, which is indicative of the subsurface reflectivity. A hypothetical source wavefield is generated by a hypothetical point source located at the marine survey receiver 722 location xᵣ below the measurement level 754. A subterranean formation 762 is illustrated. The dotted directional arrow 764 and solid directional arrow 766 represent paths that different portions of the source wavefield generated by the point source take in reaching the measurement level 754. The dotted directional arrow 764 represents a portion of the source wavefield generated by the point source that is reflected off the subterranean formation 762, off the sea surface 709, and again off the subterranean formation 762 before reaching the measurement level 754 at a location corresponding to a location where the directional arrow 756 first reached the measurement level 754. The dotted directional arrow 764 corresponds to the directional arrow 756 and represents a multiple reflection. The solid directional arrow 766 represents a portion of the source wavefield generated by the point source that is reflected off the subterranean formation 762 before reaching the measurement level 754 at a location where the directional arrow 758 first reached the measurement level 754. The solid directional arrow 766 corresponds to the directional arrow 758 and represents a primary reflection.

Rayleigh's reciprocity theorem can be applied using the wavefields in the two states to obtain an integral equation for computing the pressure wavefield generated by the marine vibrator source at xᵣ and a receiver at xₛ as:

sp_{B}(x_{S},x_{R})=iωρ∫(p_{A}(χ,z^{l}|x_{S})v_{B}(χ,z^{l}|x_{R})−p_{B}(χ,z^{l}|x_{R})v_{A}(χ, z^{l}|x_{S})dχ (3)

In Equation 3, Sommerfeld's radiation condition was applied to reduce the closed integration surface to an integration in the plane z=z′.

In a small source-free depth interval around the measurement level z=z′, wavefield separation can be used to derive the wavefield identify ∫_{∂V}_{₁}(p_{B}v_{A}−v_{B}p_{A})dS=2∫_{∂V}_{₁}(p_{B}⁻v_{A}⁺v_{A}⁻p_{B}⁻)dS. Based on this identity and using the fact that there is no up-going wavefield at the measurement level below the source in state A, the total pressure wavefield can be obtained from Equation 3:

sp_{B}(x_{S},x_{R})=−2iωρ∫(p_{B}⁻(χ, z^{l}|x_{R})v_{A}⁻(χ,z^{l}|x_{S}))dχ. (4)

After applying source receiver reciprocity in state B and taking only the up-going part of the wavefields:

p⁻(x_{R},x_{S})=−2iωρ∫(P_{B}⁻⁺(x_{R}|χ,z^{l})v_{A}⁺(χ,z^{l}|x_{S}))dχ (5)

After applying source receiver reciprocity, the wavefield originally up-going for receivers at the separation level becomes down-going for virtual sources at the separation level. This is denoted by the second sign “+” of the wavefield p_{B}⁻⁺.

On the left hand side of Equation 5, the source-receiver reciprocal of the pressure wavefields in state B (on the left hand side of Equation 4) is a Green's function multiplied with the source signature (with harmonic distortion included), which represents the total actual pressure wavefield generated by the marine vibrator source xₛ and measured at the receiver position xᵣ.

The up-going pressure wavefield on the left hand side of Equation 5 is expressed by the coupling of two wavefields in the surface integral on the right hand side. These wavefields are the direct down-going velocity wavefield v⁺(χ, z^{l} |x_{S}) at the coupling (or separation) level and the total (including all multiples) up-going pressure wavefield p_{B}⁻⁺(x_{R}|χ, z^{l}). As the later wavefield was obtained by receiver-source reciprocity application from an initially up-going wavefield at the coupling level, the pressure wavefield p_{B}⁻⁺(x_{R}|χ, z^{l}) is consequently purely down-going at the source side. This is indicated by the second sign (the plus sign) in the wavefield denotation. The pressure wavefield p⁻⁺(x_{R}|χ, z^{l}) is an up-going pressure wavefield with a Dirac impulse as a source signature effect (impulse response of the subsurface or reflectivity function) and down-going at the source position. The pressure wavefield p_{B}⁻⁺ is a receiver side and source side deghosted wavefield with the source signature effect removed. Herewith, Equation 1 has been derived.

From the known up-going pressure wavefield p⁻ and the direct incident down-going velocity wavefield v⁺, the up-going source deghosted and designatured pressure wavefield p_{B}⁻⁺ may be obtained by solving the integral Equation 5, for arbitrarily complex subsurfaces and sea surface conditions. This technique generalizes conventional source designature and deghosting approaches that have been derived assuming flat sea surfaces and/or horizontally layered media.

The integral Equation 5 is known as a Fredholm integral of the first kind. In order to solve Equation 5 for the source deghosted and designatured wavefield, Equation 5 can be written in matrix form:

P⁻=P⁻⁺V_{A}⁺. (6)

The rows of the matrices P⁻, P⁻⁺, and V_{A}⁺ in Equation 6 correspond to fixed receivers and variable sources of the total measured up-going pressure wavefield p⁻(x_{R}, x_{S}), the scaled direct down-going velocity wavefield −2iωρv_{A}⁺(χ, z^{l}|x_{S}) (where both input wavefields include the same source generated harmonic distortion), and the source deghosted and designatured up-going pressure wavefield p_{B}⁻⁺(x_{R}|χ, z^{l}). The later wavefield can be obtained from Equation 6 by matrix operations free of harmonic distortion. In order to stabilize the inversion for the deghosted and designatured pressure wavefield P⁻⁺ in Equation 6, multiplication can be performed from the right with the transposed and complex conjugated matrix (V̅_̅{̅A̅}̅⁺̅)^{T}, an M×M identity matrix I, and a small positive value ϵ as:

P⁻⁺=P⁻(V̅_̅{̅A̅}̅⁺̅)^{T}[V⁺(V̅_̅{̅A̅}̅⁺̅)^{T}+Iϵ]⁻¹. (7)

If sufficient data is available, Equation 7 can be used to compute the searched for deghosted and designatured pressure wavefield.

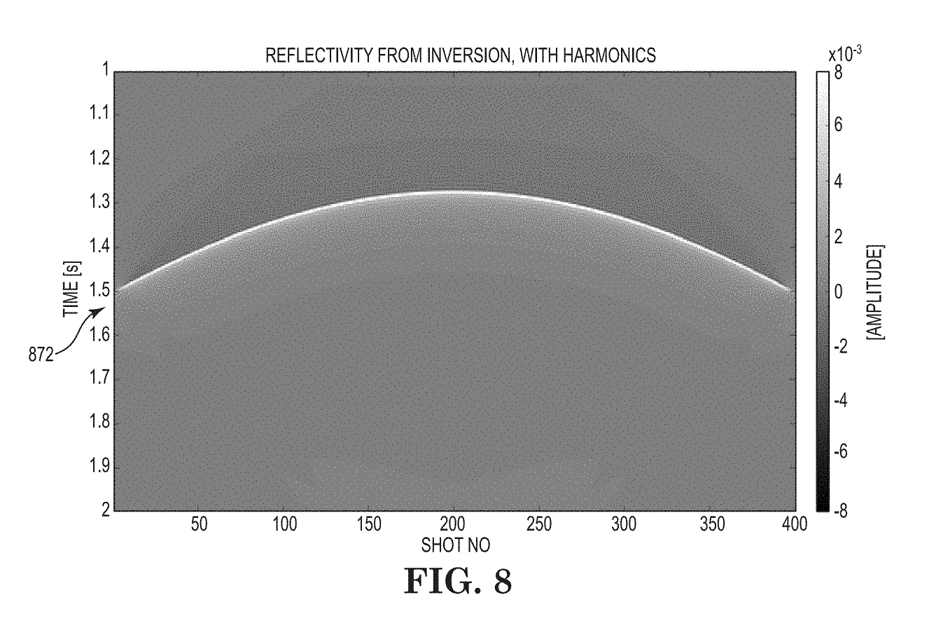

FIG. 8 illustrates calculated subsurface reflectivity 872 based on a multidimensional deconvolution of modeled data with harmonic distortion according to at least one embodiment of the present disclosure. The vertical axis is time in seconds. The horizontal axis is shot number. The shading gradation represents relative amplitude. The subsurface reflectivity 872 can be calculated using Equation 2. As can be seen in the image in FIG. 8, neither harmonics artefacts nor a source ghost effect are present (contrast with FIG. 5). Thus, the results represent an improvement over imaging according to previous approaches. The improvement in imaging can help to identify subterranean formations more accurately and clearly. The ability to better identify subterranean formations can make exploration for and extraction of hydrocarbons, a commercially valuable resource, more efficient.

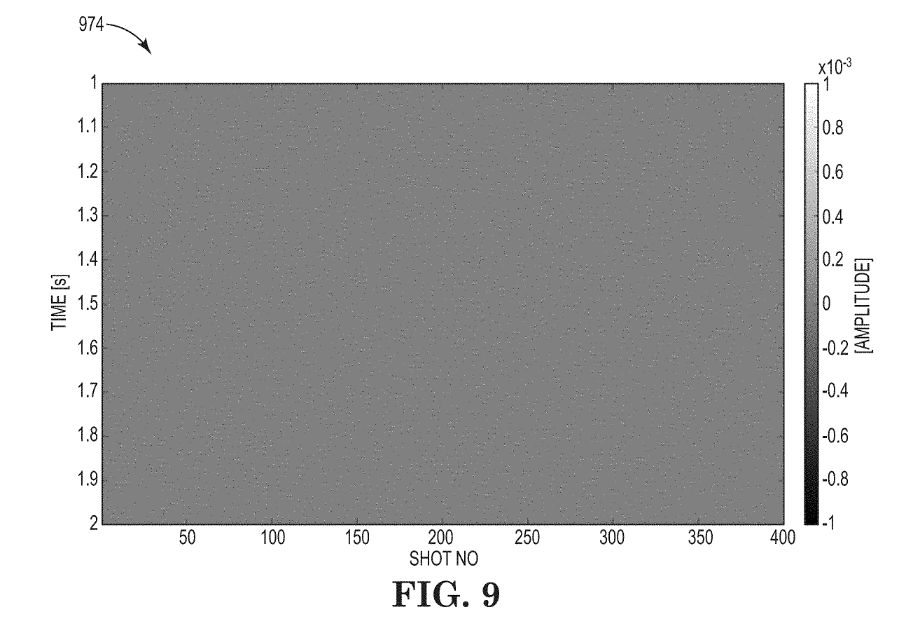

FIG. 9 illustrates the difference 974 between the calculated subsurface reflectivity in FIG. 8 and the modeled subsurface reflectivity in FIG. 5. The vertical axis is time in seconds. The horizontal axis is shot number. The shading gradation would represent relative amplitude, however, the image in FIG. 9 illustrates that there is essentially no difference 974 between the calculated subsurface reflectivity based on a multidimensional deconvolution of modeled data with harmonic distortion according to at least one embodiment of the present disclosure and the modeled subsurface reflectivity. Therefore, the image appears as a grayscale block with no discernable gradation. This indicates a very accurate calculation of the subsurface reflectivity.

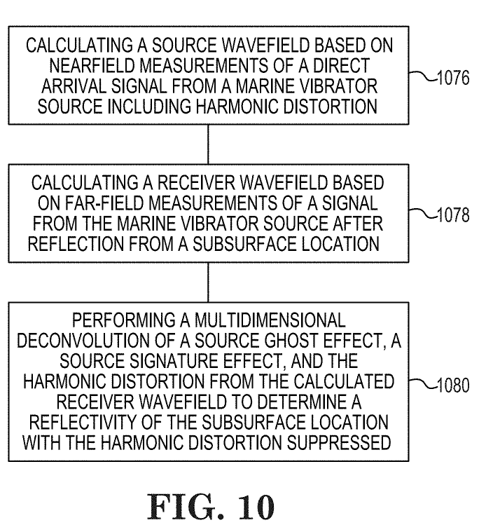

FIG. 10 is an example of a method flow diagram for marine seismic use of a harmonic distorted signal. At block 1076, the method can include calculating a source wavefield based on nearfield measurements of a direct arrival signal from a marine vibrator source including harmonic distortion. The output of the marine vibrator source can include harmonic distortion, therefore the nearfield measurements can include harmonic distortion, and therefore the calculated source wavefield can include harmonic distortion. At block 1078, the method can include calculating a receiver wavefield based on far-field measurements of a signal from the marine vibrator source after reflection from a subsurface location. At block 1080, the method can include performing a multidimensional deconvolution of a source ghost effect, a source signature effect, and the harmonic distortion from the calculated receiver wavefield to determine a reflectivity of the subsurface location with the harmonic distortion suppressed. Performing the multidimensional deconvolution can include inverting a Fredholm integral as described above with respect to FIG. 7. In at least one embodiment, the method can include generating an image of the subsurface location based on the subsurface reflectivity. Such an improved image can be useful for those responsible for making decisions where and whether to prospect for hydrocarbons in subsurface locations.

In at least one embodiment, the method does not include applying a cross-correlation to the calculated source wavefield and the calculated receiver wavefield, as opposed to some previous approaches. In at least one embodiment, the method does not include using iterative learning control to suppress the harmonic distortion. In contrast, the harmonic distortion can be useful for the multidimensional deconvolution to provide more broadband information regarding the subsurface reflectivity than can be obtained using only harmonics-free data or by suppressing the harmonics.

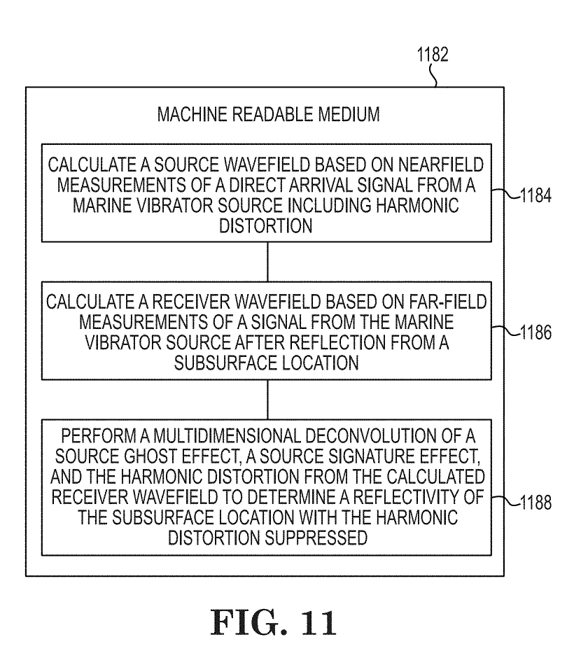

FIG. 11 illustrates a diagram of an example of a machine-readable medium 1182 for marine seismic use of a harmonic distorted signal. The machine-readable medium 1182 can be non-transitory. The machine-readable medium 1180 can, in at least one embodiment, be analogous to the memory resource 1292 illustrated in FIG. 12. The machine-readable medium 1180 can store instructions executable by a processing resource. For example, at 1184, the machine-readable medium 1180 can store instructions executable to calculate a source wavefield based on nearfield measurements of a direct arrival signal from a marine vibrator source including harmonic distortion. At 1186, the machine-readable medium 1180 can store instructions executable to calculate a receiver wavefield based on far-field measurements of a signal from the marine vibrator source after reflection from a subsurface location. At 1188, the machine-readable medium 1180 can store instructions executable to perform a multidimensional deconvolution of a source ghost effect, a source signature effect, and the harmonic distortion from the calculated receiver wavefield to determine a reflectivity of the subsurface location with the harmonic distortion suppressed. Although not specifically illustrated, the machine-readable medium 1180 can store instructions executable to generate an image of the subsurface location based on the subsurface reflectivity. Such an image can be useful to prospectors seeking to extract hydrocarbons that may be associated with the subsurface location.

FIG. 12 illustrates a diagram of an example of a system for marine seismic use of a harmonic distorted signal. As illustrated in FIG. 12, the source wavefield 1294, the receiver wavefield 1296, and the subsurface reflectivity 1298 each depict data conceptually representing the physical wavefields or reflectivity. The system can include a controller 1219 that, in at least one embodiment, can be analogous to or implemented by the controller 119 illustrated in FIG. 1. In at least one embodiment, the controller 1219 can represent functionality that is partially implemented by the controller 119 illustrated in FIG. 1 and partially implemented by a different controller, such as a different controller onboard the marine survey vessel or on shore. For example, the controller 1292 being analogous to the controller 119 illustrated in FIG. 1 can be configured to operate the marine vibrator source 1226 and receive data from the nearfield receivers 1222-1 and the far-field receivers 1222-2, while a different controller can be configured to perform the functions described herein with respect to the source wavefield 1294, the receiver wavefield 1296, and the subsurface reflectivity 1298. For ease of explanation, the controller 1219 will be referred to herein as a single physical controller, however embodiments are not so limited. The marine vibrator source 1226 is analogous to the marine vibrator source 126 illustrated in FIG. 1. The nearfield receivers 1222-1 are analogous to the nearfield receivers 122-1 illustrated in FIG. 1. The far-field receivers 1222-2 are analogous to the far-field receivers 122-2 illustrated in FIG. 1.

The system can utilize software, hardware, firmware, and/or logic to perform a number of functions. The system can be a combination of hardware and executable instructions configured to perform a number of functions (e.g., actions). The hardware, for example, can include a processing resource 1290, such as at least one processor, and a memory resource 1292, such as a machine-readable medium or other non-transitory memory resource 1292. The memory resource 1292 can be internal and/or external to the system. For example, the system can include an internal memory resource and have access to an external memory resource. Executable instructions can be stored on the machine-readable medium as machine-readable and executable and to implement a particular function. For example, the executable instructions can be executed by the processing resource 1290. The memory resource 1292 can be coupled to the system in a wired and/or wireless manner. For example, the memory resource 1292 can be an internal memory, a portable memory, a portable disk, and/or a memory associated with another resource, for example, enabling the executable instructions to be transferred and/or executed across a network such as the Internet. In at least one embodiment, the memory resource 1292 can be a plurality of non-transitory machine-readable media.

The memory resource 1292 can be non-transitory and can include volatile and/or non-volatile memory. Volatile memory can include memory that depends upon power to store information, such as various types of dynamic random access memory among others. Non-volatile memory can include memory that does not depend upon power to store information. Examples of non-volatile memory can include solid state media such as flash memory, electrically erasable programmable read-only memory, phase change random access memory, magnetic memory, optical memory, and/or a solid state drive, etc., as well as other types of non-transitory machine-readable media.

The processing resource 1290 can be coupled to the memory resource 1292 via a communication path. The communication path can be local or remote to system. Examples of a local communication path can include an electronic bus internal to a machine, where the memory resource 1292 is in communication with the processing resource 1290 via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path can be such that the memory resource 1292 is remote from the processing resource 1290, such as in a network connection between the memory resource 1292 and the processing resource 1290. That is, the communication path can be a network connection. Examples of such a network connection can include a local area network, wide area network, personal area network, and the Internet, among others.

The processing resource 1290 can calculate and the memory resource 1292 can store a source wavefield 1294, comprising a direct down-going wavefield generated by the marine vibrator source, based on input from the plurality of nearfield receivers including harmonic distortion. The processing resource 1290 can calculate and the memory resource 1292 can store a receiver wavefield 1296, comprising an up-going wavefield, based on input from the plurality of far-field receivers corresponding to a signal from the marine vibrator source after reflection from a subsurface location. The processing resource 1290 can perform a multidimensional deconvolution of a source ghost effect, a source signature effect, and the harmonic distortion from the calculated receiver wavefield to determine a reflectivity of the subsurface location with the harmonic distortion suppressed and the memory resource 1292 can store the subsurface reflectivity 1298. The controller 1219 can be configured to generate an image of the subsurface location based on the subsurface reflectivity. Although the system can include more than one marine survey source, such as the marine vibrator source 1226, for purposes of performing the multidimensional deconvolution to calculate the subsurface reflectivity, in at least one embodiment, when the marine vibrator source 1226 is operating, no other marine survey sources are operating. Such embodiments can be advantageous in preventing other interference from being misinterpreted as part of the harmonic distortion, which may otherwise adversely affect the results of the multidimensional convolution.

The controller 1219 can be configured to operate the marine vibrator source 1226 with a sweep signal having an operational portion from a starting frequency to a stopping frequency over a period of time. The controller 1219 can be configured to calculate the receiver wavefield 1296 based on the input from the far-field receivers 1222-2 including amplitudes at frequencies outside the operational portion. The controller 1219 can be configured to select the frequencies outside the operational portion for which it receives data from the far-field receivers 1222-2 or for which it performs calculations. The selected frequencies can be a multiple of the operational portion of the sweep signal such that amplitudes included in the frequencies outside the operational portion include out-of-band harmonics (see FIG. 2A for examples). As opposed to attempting to avoid receiving harmonic distortion, the present disclosure seeks to obtain as much information as possible from the harmonic distortion in frequency ranges outside of the operational range of the marine vibrator source 1226 in order to provide useful broadband information about the subsurface reflectivity 1298, that otherwise would be missing if the harmonics were suppressed or not used in the performance of the multidimensional deconvolution.

The controller 1219 can be configured to model a modeled source wavefield without harmonic distortion corresponding to the source wavefield generated by the marine vibrator source 1226. The modeled source wavefield can be used by the controller 1219 in the multidimensional deconvolution, for example, as described above with respect to FIG. 7. The controller 1219 can be configured to calculate a difference between the modeled source wavefield and the calculated source wavefield 1294, for example, as described above with respect to FIG. 9.

In accordance with a number of embodiments of the present disclosure, a geophysical data product may be produced by obtaining geophysical data from operation of a marine vibrator source, calculating a source wavefield based on nearfield measurements of a direct arrival signal from the marine vibrator source including harmonic distortion, calculating a receiver wavefield based on far-field measurements of a subsurface reflected signal from the marine vibrator source, performing a multidimensional deconvolution of a source ghost effect and a source signature effect from the calculated receiver wavefield to determine a subsurface reflectivity with the harmonic distortion suppressed. The geophysical data can be recorded on a non-transitory, tangible machine-readable medium thereby generating the geophysical data product. The geophysical data product may be produced by performing the multidimensional deconvolution offshore or onshore either within the United States or in another country. If the geophysical data product is produced offshore or in another country, it may be imported onshore to a facility in the United States.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for marine seismic use of a harmonic distorted signal, comprising:
calculating a source wavefield based on nearfield measurements of a direct arrival signal from a marine vibrator source including harmonic distortion;
calculating a receiver wavefield based on far-field measurements of a signal from the marine vibrator source after reflection from a subsurface location; and
performing a multidimensional deconvolution of a source ghost effect, a source signature effect, and the harmonic distortion from the calculated receiver wavefield to determine a reflectivity of the subsurface location with the harmonic distortion suppressed.

2. The method of claim 1, wherein the method does not include applying a cross-correlation to the calculated source wavefield and the calculated receiver wavefield.

3. The method of claim 1, wherein the method does not include using iterative learning control to suppress the harmonic distortion.

4. The method of claim 1, wherein the method does not include suppressing the harmonic distortion prior to performing the multidimensional deconvolution.

5. The method of claim 1, further comprising generating an image of the subsurface location based on the subsurface reflectivity.

6. The method of claim 1, wherein performing the multidimensional deconvolution comprises inverting a Fredholm integral.

7. A system for marine seismic use of a harmonic distorted signal, comprising:
means for calculating a source wavefield including harmonic distortion based on nearfield measurements of a direct arrival signal from a marine vibrator source;
means for calculating a receiver wavefield based on far-field measurements of a signal from the marine vibrator source after reflection from a subsurface location; and
means for performing a multidimensional deconvolution of a source ghost effect, a source signature effect, and the harmonic distortion from the calculated receiver wavefield to determine a reflectivity of the subsurface location with the harmonic distortion suppressed.

8. The system of claim 7, further comprising means for generating an image of the subsurface location based on the subsurface reflectivity.

9. A non-transitory machine-readable medium storing instructions for marine seismic use of a harmonic distorted signal executable by a processing resource to:
calculate a source wavefield based on nearfield measurements of a direct arrival signal from a marine vibrator source including harmonic distortion;
calculate a receiver wavefield based on far-field measurements of a signal from the marine vibrator source after reflection from a subsurface location;
perform a multidimensional deconvolution of a source ghost effect, a source signature effect, and the harmonic distortion from the calculated receiver wavefield to determine a reflectivity of the subsurface location with the harmonic distortion suppressed.

10. The medium of claim 9, further comprising instructions to generate an image of the subsurface location based on the subsurface reflectivity.

11. A system for marine seismic use of a harmonic distorted signal, comprising:
a marine vibrator source;
a plurality of nearfield receivers deployed proximally to the marine vibrator source;
a plurality of far-field receivers deployed distally to the marine vibrator source; and
a controller coupled to the marine vibrator source, the plurality of nearfield receivers, and the plurality of far-field receivers, wherein the controller is configured to:
calculate a source wavefield, comprising a direct down-going wavefield generated by the marine vibrator source, based on input from the plurality of nearfield receivers including harmonic distortion;
calculate a receiver wavefield, comprising an up-going wavefield, based on input from the plurality of far-field receivers corresponding to a signal from the marine vibrator source after reflection from a subsurface location; and
perform a multidimensional deconvolution of a source ghost effect, a source signature effect, and the harmonic distortion from the calculated receiver wavefield to determine a reflectivity of the subsurface location with the harmonic distortion suppressed.

12. The system of claim 11, wherein the controller is further configured to:
operate the marine vibrator source with a sweep signal having an operational portion from a starting frequency to a stopping frequency over a period of time;
calculate the receiver wavefield based on the input from the plurality of far-field receivers including amplitudes at frequencies outside the operational portion.

13. The system of claim 12, wherein the controller is further configured to select the frequencies outside the operational portion as a multiple of the operational portion such that amplitudes included in the frequencies outside the operational portion include a plurality of out-of-band harmonics.

14. The system of claim 11, wherein the system does not include other sources operating during operation of the marine vibrator source.

15. The system of claim 11, wherein the controller is further configured to model a source wavefield without harmonic distortion corresponding to the source wavefield generated by the marine vibrator source.

16. The system of claim 15, wherein the controller is further configured to use the modeled source wavefield in the multidimensional deconvolution.

17. The system of claim 15 wherein the controller is further configured to calculate a difference between the modeled source wavefield and the calculated source wavefield.

18. The system of claim 11, wherein the controller is further configured to generate an image of the subsurface location based on the subsurface reflectivity.

19. A method of manufacturing a geophysical data product, the method comprising:
obtaining geophysical data from operation of a marine vibrator source;
calculating a source wavefield based on nearfield measurements of a direct arrival signal from the marine vibrator source including harmonic distortion;
calculating a receiver wavefield based on far-field measurements of a signal from the marine vibrator source after reflection from a subsurface location;
performing a multidimensional deconvolution of a source ghost effect and a source signature effect from the calculated receiver wavefield to determine a subsurface reflectivity with the harmonic distortion suppressed; and
recording the geophysical data on a non-transitory machine-readable medium thereby generating the geophysical data product.

20. The method of claim 19, wherein performing the multidimensional deconvolution comprises performing the multidimensional deconvolution offshore or onshore.
